(19) United States
(12) Patent Application Publication
(10) Pub. No.: US 2009/0248793 A1
(43) Pub. Date: Oct. 1, 2009

(54) Providing Content In a Network

(75) Inventors: Sanny Jacobsson, Hedekas (SE); Mikael Eiman, Ytterby (SE); John Sjolander, Goteborg (SE)

Correspondence Address: FISH & RICHARDSON P.C., PO BOX 1022, MINNEAPOLIS, MN, 55440-1022, US

(73) Assignee: CONTRIBIO AB, Goteborg (SE)

(21) Appl. No.: 12/054,986

(22) Filed: Mar. 25, 2008

(51) Int. Cl. G06F 15/16

(52) U.S. Cl. 709/203

(57) ABSTRACT

Among other disclosed subject matter, a computer program product includes instructions that when executed by a processor perform a method for providing content in a network. The method includes receiving an identifier that is forwarded from a device in a network and associated with content divided into content portions that are to be delivered to the device. The method includes selecting a content source in the network for each of the respective content portions, wherein for at least one of the content portions the content source is selected among multiple content sources associated with the respective content portion using recorded information about the multiple content sources. The method includes forwarding, in response to the identifier, source information to the device that identifies each selected content source and is configured for use by the device in requesting at least one of the multiple content portions from each selected content source.

### TECHNICAL FIELD

This document relates to providing content.

### BACKGROUND

Many types of content are distributed in computer networks. For example, music files, video files, data files and software program code are often distributed over a private computer network, such as within an organization, and/or over a public network, such as the internet. Access to some content is restricted, for example to limit its distribution or to enable the provider to charge a fee.

Peer-to-peer distribution is sometimes used, where individual computers or systems can act as peers and participate in the content distribution by passing content between each other. However, content delivery in a peer-to-peer network can have varying quality depending on who the participants are, and uneven distribution patterns can place a significant traffic burden on the hosts and/or internet service providers of some participants.

### SUMMARY

The invention relates to providing content.

In a first aspect, a computer program product is tangibly embodied in a computer-readable storage medium and includes instructions that when executed by a processor perform a method for providing content in a network. The method includes receiving an identifier that is forwarded from a device in a network and associated with content divided into content portions that are to be delivered to the device. The method includes selecting a content source in the network for each of the respective content portions, wherein for at least one of the content portions the content source is selected among multiple content sources associated with the respective content portion using recorded information about the multiple content sources. The method includes forwarding, in response to the identifier, source information to the device that identifies each selected content source and is configured for use by the device in requesting at least one of the multiple content portions from each selected content source.

Implementations can include any, all or none of the following features. Selecting the content source can include applying an optimization algorithm to the recorded information. The optimization algorithm can be configured so that the at least one content source is selected according to at least one approach selected from: a network separation between the device and the content source being at most a predefined number of jumps; a cost of forwarding at least one of the multiple content portions from the content source to the device being minimized; a time required to forward at least one of the multiple content portions from the content source to the device being minimized; a likelihood of successful forwarding of at least one of the multiple content portions from the content source to the device being maximized; the content source being located in a predefined network in which the device is also located; the content source being associated with an internet service provider with which the device is also associated; the content source being located in a geographic location in which the device is also located; and combinations thereof. The recorded information can reflect at least one characteristic selected from: a speed of communication to the device; a speed of communication from the device; whether communication with the content source has been successful; whether the content source has a public internet protocol (IP) address; whether the content source has a private IP address; an internet service provider with which the content source is associated; a geographic location with which the content source is associated; a subnet in which the content source is located; and combinations thereof. The source information can identify a plurality of content sources for at least one of the content portions. The content can include at least one content type selected from: audio content, image content, video content, application program content, and combinations thereof. The method can further include receiving a confirmation from the device after the device requests the multiple content portions, the confirmation including information about a result of the requests generated by the device; and updating the recorded information using the confirmation. The method can further include registering the device as a content source for the content.

In a second aspect, a computer program product is tangibly embodied in a computer-readable storage medium and includes instructions that when executed by a processor perform a method for providing content in a network. The method includes forwarding an identifier associated with an object from a device to a first server device in a network, the object including content divided into content portions that are to be delivered to the device. The method includes receiving, at the device and from the first server device, source information that identifies a selected content source for each of the respective content portions, wherein for at least one of the content portions the content source was selected among multiple content sources associated with the respective content portion using recorded information about the multiple content sources. The method includes obtaining the content using the received source information.

Implementations can include any, all or none of the following features. The instructions can be included in a program on the device that is associated with the first server device, the program configured to interact with a browser on the device presenting the page that was received from a second server device. The program can be configured to initiate installation of software on the device and the content can include the software, and the method can further include installing the software on the device from the content. The method can further include receiving an input from the user indicating that at least one part of the software is not to be installed; and providing that any of the content portions corresponding to the part are not requested by the device. The method can further include displaying, before forwarding the identifier, a page on the device that includes a representation of the object; and obtaining the identifier from the displayed page upon a user selecting the representation of the object. The page can include script code associated with the representation of the object, the script code instructing the device to obtain the identifier from the page upon the user selecting the representation and forward the identifier to the program, wherein the program forwards the identifier to the first server device. Obtaining the content can include specifying, for each of the content portions, a range command corresponding to the content portion being requested; and forwarding a request including the range command to the content source for the content portion. The method can further include sending a confirmation from the device to the first server device after the device requests the multiple content portions, the confirmation including information about a result of the requests generated by the device, wherein the first server device updates the recorded information using the confirmation

In a third aspect, a computer system includes a communication module receiving an identifier that is forwarded from a device in a network and associated with content divided into content portions that are to be delivered to the device. The computer system includes a source selection module selecting a content source in the network for each of the respective content portions, wherein for at least one of the content portions the content source is selected among multiple content sources associated with the respective content portion using recorded information about the multiple content sources. The communication module forwards, in response to the identifier, source information to the device that identifies each selected content source and is configured for use by the device in requesting at least one of the multiple content portions from each selected content source.

In a fourth aspect, a computer program product is tangibly embodied in a computer-readable storage medium and includes instructions that when executed by a processor perform a method for providing content in a network. The method includes receiving, at a first server device and from a device in a network, an identifier that is associated with content divided into content portions that are to be delivered to the device, wherein to obtain the identifier the device: displays in a browser a page including a representation of an object that includes the content, the representation associated with the identifier and the page provided to the device from a second server device, wherein a user selects the representation on the page; forwards the identifier from the browser to a program on the device that is associated with the first server device, the identifier forwarded according to communication instructions provided from the first server device; and forwards the identifier to the first server device using the program. The method includes selecting, at the first server device and using the received identifier, at least one of a plurality of third server devices in the network as a content source for each of the respective content portions, wherein for at least one of the content portions the content source is selected by applying an optimization algorithm to recorded information about the plurality of third server devices. The method includes forwarding, in response to the identifier, object information and source information to the device, the object information describing the object and the multiple content portions, the source information identifying each selected content source, wherein the device: obtains the content using the received object information and source information using the program; forwards the obtained content from the program to the browser; and presents the content in the browser.

Implementations can provide any, all or none of the following advantages. Improved content distribution can be provided. Control of network traffic can be improved, for example to control the costs of downloads. Downloads can be organized to occur from only sources selected by a central coordinator. Ability to customize content distribution can be provided.

The details of one or more embodiments are set forth in the accompanying drawings and the description below. Other features and advantages will be apparent from the description and drawings, and from the claims.

### DESCRIPTION OF DRAWINGS

FIG. 1 shows an example of a system for delivering content over a network.

FIG. 2 shows an example of data exchange between multiple devices in a network.

FIG. 3 shows an example of a process for delivering content over a network.

FIG. 4 is a block diagram of a computing system that can be used in connection with computer-implemented methods described in this document.

Like reference symbols in the various drawings indicate like elements.

### DETAILED DESCRIPTION

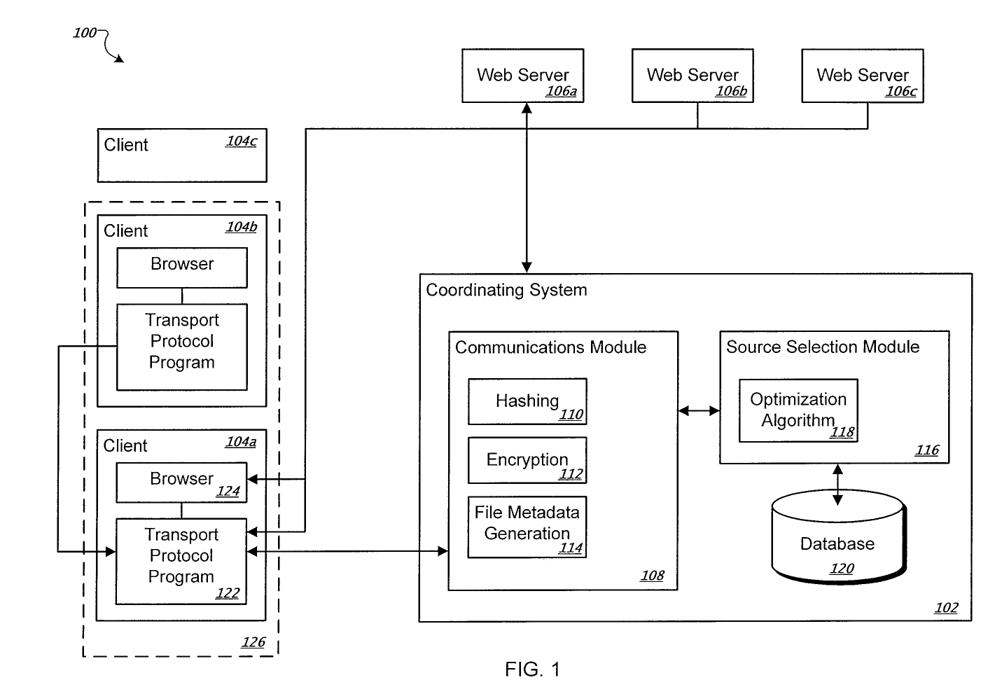

FIG. 1 is a schematic diagram of an example of a computer system 100 for delivering content over a network. In one embodiment, the system 100 can integrate with an existing web infrastructure using an existing communications protocol such as HTTP to transfer digital content over the Internet. Many types of content can be delivered, including, but not limited to, audio content, image content, video content, and application program content.

The system 100 in this example includes a coordinating system 102, a plurality of clients 104a, 104b, and 104c, and a plurality of web servers 106a, 106b, and 106c. The system 100 can in part rely on peer-to-peer techniques to deliver content to one or more clients, while providing centralized control to improve the speed, reduce the cost, and/or to increase the reliability of data transfer. Components in the system 100 can be connected by any kind of network, such as the internet.

The coordinating system 102 is the central component of the system 100 in this implementation, and can for example be responsible for managing and directing the flow of data traffic through the network from one or more content providers to one or more content consumers. For example, the coordinating system 102 can be a computer application running on a server independent of servers operated by content providers. This arrangement can reduce or eliminate a burden on content providers to maintain additional servers in order to handle increased network traffic, while producing the benefit of improved data transfer provided by a larger network of client peers. In other implementations, content providers can run the coordinating system 102 on their own servers.

The coordinating system 102 here includes a communications module 108 which handles system communications with client devices and/or content providers. The communications module 108 here includes multiple functions, including a hashing function 110, an encryption function 112, and a file metadata generation function 114. These functions can be employed as part of a process that a content provider can follow in making content available for delivery.

The coordinating system 102 here also includes a source selection module 116 which can select one or more content sources from a set of multiple content sources and identify the selected source(s) to a client device that has requested certain content. In some implementations, the source selection module 116 includes an optimization algorithm 118 which can handle the selection of optimal content sources for a particular request, for example based on recorded information stored in a database 120 and based on a set of prioritized selection rules.

The clients 104a, 104b, and 104c are devices that in some implementations can serve as content sources as well as requesters of content. After a particular portion of content has been delivered to a client, that client can from then on be considered by the system 100 as an available content source for that portion. Client devices can be capable of interacting with the coordinating system 102, web servers, and other client devices.

The web servers 106a, 106b, and 106c can be content sources. As another example, one or more of the servers 106a-c can provide a page published by a content provider that allow the clients 104a, 104b, and 104c to request content originating in the sources. That is, the server(s) can publicize the availability of content that can be provided on behalf of the content source.

Initially, a content provider can supply a source file containing content that the content provider seeks to make available to consumers in the network. For example, suppose a content provider desires to make a 200 MB video file available for delivery by the system 100 to interested consumers. The content provider can serve the source file to the coordinating system 102 by providing a file location for retrieval or through direct transfer or some similar method, to name a few examples. In some implementations of the system 100, a 200 MB file is sufficiently large that it could be considered inconvenient for wide-scale delivery in one piece. For example, a dropped connection between a client and a provider in the middle of the download process in such a situation can result in the loss of the entire file. As another example, it may require a substantial amount of resources on the server side to repeatedly provide a 200 MB file.

A large file can therefore be divided into multiple smaller portions, each suitable for transfer to a client from one or more content sources. The size of each file portion can be determined by several factors, such as the type of file content, the prevailing network speed and stability, and the overhead associated with managing multiple components, to name a few examples.

In the present example, the coordinating system determines that the 200 MB video file is to be divided into 390 portions, each portion roughly 512 KB in size. To protect content from unauthorized access during delivery, each of the 390 file portions can be encrypted by the encryption function 112. Any encryption technique can be used. For example, an encryption according to Advanced Encryption Standard (AES) can be used. Each of the 390 portions can be processed by the hashing function 112 in order to generate a set of corresponding hash values, the hash values providing a way for client devices to later check the integrity of corresponding file portions. In some implementations, the hashing can be performed on the encrypted contents. Any hashing technique can be used, such as the secure hashing algorithm sometimes referred to as SHA. The encryption key(s) can be supplied to client devices by the coordinating system 102 if the devices provide proper credentials for requested content. Through encryption, it can for example be possible for providers to seed the network with content prior to official content release and then make the encryption key (or equivalent) available when the content is to be made available for consumption.

As another example, the contents can be processed by the metadata generation function 114. In some implementations, the function 114 generates information about portions of a file, such as portion identifiers, portion sizes, portion hash values, and/or encryption keys. The file metadata can be stored by the coordinating system 102 and be sent to clients who request content.

The 390 encrypted file portions can be sent from the coordinating system 102 to the content provider, optionally together with other information relating to the portions and/or to the source file. In this example, the content provider places the 390 file portions on the web server 106a. At this point, the file portions stored on the server 106a may be the only version of the file available in the system 100, unless the file has previously been shared or distributed. The content provider can then announce to consumers that the file content is being made available. For example, the content provider can create a web page containing an identifier for the contents, and place the web page on the web server 106a or, as another example, on another server such as the web server 106b. The created web page having the content identifier can then be used by one or more persons or entities to access the content of the video file, for example as will now be described. In some implementations, such a page can be made available only to authorized consumers and not to the general public, and in other implementations, the page can be made generally available but downloading of the contents may require an authorization procedure, to name just a few examples.

In some implementations, the client device can obtain the identifier other than from a webpage or from any page. For example, an identifier for a program to be downloaded and installed can be obtained from a program database through a suitable interface with the client device. In other implementations, the client device can have no or only limited screen functionality. For example, the client device can be an internet radio or other music player that downloads content from selected sources.

To be able to request content in the system 100 and thereafter share received contents with others, the client 104a can first install a transport protocol program 122 that handles communication with the coordinating system 102 and handles the download of data. In some implementations this is done ahead of time and can then be considered a form of setup procedure for participating in content exchange. The transport protocol program 122 can, for example, be a program that runs separately and independently from a browser on the client device. In some implementations, the browser 124 can communicate with the transport protocol program 122 through a device port. In such implementations, the browser can be provided with a plug-in that identifies a port—e.g., port 80—for use in communicating with the program 122. Any other method of communication with the program 122, such as a file-based method, can be used. In another implementation, for example, the transport protocol program 122 can be a browser plug-in, such as a QuickTime component, and can operate from within the browser 124.

In some implementations, the program 122 works in connection with the browser 124 as illustrated. In other implementations, the program 122 can work in connection with another program or component that uses downloaded information, such as with a media player, with a CD/DVD recording device, with an application for analyzing information and/or with a software installation program, to name a few examples. As another example, the program 122 can include the functionality that uses the downloaded data. In some implementations, the program 122 is configure to download a selected amount of data in advance of it being requested or needed. As other examples, the number of parallel download connections and/or any limits on upload and/or download speed can be regulated.

The client 104a can instruct the browser 124 to access a web page located on web server 106b. For example, this can occur when a user of the client 104a is surfing the internet, looking for pages and/or content that the user might find interesting. In response to a request from the client 104a, code corresponding to the web page can be delivered from the server 106b to the client 104a. When the web page is displayed to the user, it can contain an object that the user can activate to initiate downloading of the content from one or more sources that can be identified as described below. That is, the web page can contain a representation of the content to be delivered, for example as a clickable icon or other object, the representation associated with an identifier for the content, to provide the user the ability to acquire the content for consumption.

Upon user selection of the content representation, for example using a pointing device, the content identifier can be forwarded from the browser 124 to the transport protocol program 122. This identifier forwarding can be accomplished through script code running in the browser, for example. The transport protocol program 122 can then forward the content identifier to the communications module 108 of the coordinating system 102, for example, along with any credentials required by the coordinating system 102 to verify that the client 104a is an authorized member of the system 100, such as user ID and/or password information. In the case that a client does not presently have the transport protocol program 122 and/or does not have the required credentials when the user clicks on the object, alternate methods of content delivery can be made available by the content provider, such as providing a link to an alternate content server. As another example, the user can be offered the ability to first download and install the program 122 and thereafter complete the download of the sought video file.

After receiving the content identifier, the communications module 108 can pass it to the source selection module 116 for the purpose of identifying a set of one or more content sources for each of the file portions. The system 102 can track the available content sources for each file portion on client devices and/or web servers. As another example, the coordinating system 102 can maintain additional information about the content sources, such as the speed of communication to and from the content sources, whether the content source has a public or private internet protocol (IP) address, the name of the internet service provider with which the content source is associated, and/or the subnet in which the content source is located. In such implementations, the source selection module 116 can retrieve any or all of this information regarding the content source(s) from the database 120 in order to assist the optimization algorithm 118 in selecting a set of content sources. In this way, the coordinating system 102 can be able to monitor traffic in the system 100 and also to manage and control traffic when any particular content is being sought.

In some implementations, the optimization algorithm 118 can be designed to take into account a set of multiple criteria in determining an optimal set of content sources for the various file portions. For example, the optimization algorithm can seek to increase network efficiency and/or to decrease the cost of network data transfer as compared with standard peer-to-peer systems. Possible content source selection criteria include, but are not limited to: a minimization of the network separation between the client device and the content source, the minimization of the costs associated with delivering data from the content source to the client device, the minimization of the time required to deliver data from the content source to the client device, the maximization of the likelihood of successful data delivery from the content source to the device, as well as the consideration of not overloading a particular content source with too many simultaneous requests. In some implementations, preference can be given to the selection of content sources associated with the same geographic location (e.g., country), network, and/or internet service provider as the client device. The source selection module 116 can select multiple content sources for each file portion for the purpose of providing multiple sources in case download from any of the sources is slow, has poor quality or is ultimately unsuccessful. In some implementations, the multiple sources for the file portion(s) are sent to the client without indicating any ranking or order between them; that is, the client decides which of the sources to try first, and so on. The identities of the set of content sources can then optionally be bundled with metadata describing the content portions, and can be sent by the communications module 108 to the transport protocol program 122 at the client 104a which requested the content.

In this example, the transport protocol program 122 at the client 104a receives the identities of the set of content sources and the metadata describing the content portions, and can then begin downloading the file portions of the requested content. For example, the client 104a can be notified that the client 104b is selected as a content source for one or more file portions. In some implementations, this selection can be done because the client 104a and the client 104b belong to a same predefined network 126. The client 104c, in contrast, does not belong to the predefined network 126 in this example, and can therefore be excluded as a content source in this example. Other participants in the system 100 can be selected as sources for the current file portion and/or for other file portions, such as any or all of the web servers 106a-c.

The client 104a can begin downloading one or more file portions from the client 104b and/or from any of the servers 106a-c, according to the sources identified to it by the system 102, using the transport protocol program 122. After downloading a file portion from the client 104b, for example, the program 122 can verify that the file portion is valid through a comparison with the corresponding hash value for that file part provided in the metadata. If the file portion is determined to be valid, the program 122 can decrypt it using a key that is for example provided in the metadata. The program 122 can then forward the content to the browser, making it available to the user.

In addition to peer clients, web servers can also be listed as content sources for one or more file portions. In this example, the web servers 106a, 106b, and 106c are all available to provide content delivery. When content is first made available for delivery, it can be the case that the file portions only exist on one or more web servers, until such time that the file portions are distributed also to one or more client devices and the coordinating system 102 becomes aware of this distribution. Accordingly, the source selection module 116 can consider the web server(s) as potential providers of content to the client at such time.

After the download of content by the client 104a, the client can send a confirmation to the coordinating system 102. This confirmation can include the results of the device requests, for example, information about the transferred file portion(s), successful transfers and transfer times. The coordinating system 102 can record these results and can later use this information to assist the source selection module 116 in the selection of content sources for subsequent content deliveries.

The data base 120 can include information about some or all of the known sources. For example, servers can be considered permanent sources and clients can be considered relatively more temporary, for example because client devices are sometimes turned off and therefore become unavailable. The database can track storage space, which can for example be of interest to network participants that can download certain material at the request of the server or the coordinator. The database can track measured or estimated times regarding the network, such as uptimes, which can indicate reliability. For example, if some material is demanded most often during office hours, the coordinator can take the availability of one or more sources into account when selecting sources.

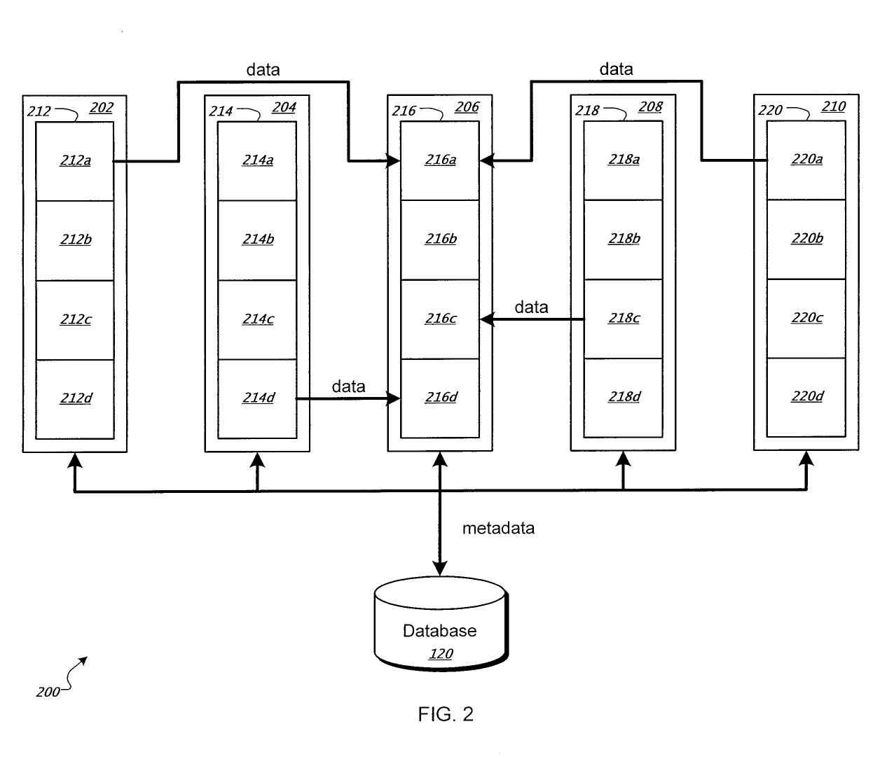

FIG. 2 is a block diagram of an example of data exchange between multiple peer client devices and/or web servers. In this example, a system 200 can include a plurality of peer client devices and/or web servers 202, 204, 206, 208 and 210, and can include the database 120. In this example, the device 206 can be a client device requesting content from one or more peer client devices and/or web servers (hereafter referred to as “devices”) 202, 204, 208 and 210. Here, for example, the device 202 has access to content 212, the device 204 has access to content 214, the device 208 has access to content 218, and the device 210 has access to content 220. In this example, the contents 212, 214, 218 and 220 can be instances of the same content, and each similar content can be divided into similar and corresponding portions. In situations where the contents 212, 214, 218 and 220 are respective versions of the same file, they are normally identical, absent errors in the data or other discrepancies. Here, for example, a portion 212a can be similar or identical to portions 214a, 218a and 220a. Continuing this example, a portion 212b can be similar or identical to portions 214b, 218b and 220b; a portion 212c can be similar or identical to portions 214c, 218c and 220c; and a portion 212d can be similar or identical to portions 214d, 218d and 220d. The content instances 212, 214, 218 or 220 in this example can include all of the content portions, or, as another example, can include a subset of the content portions. For example, the content 212 can constitute an entire data file (e.g., a large video file) or part thereof.

In this example, the client device 206 can request a content instance 216 to be provided to the client device 216, the content instance 216 similar to the content instances 202, 204, 208 and 210. The content instance 216 can be divided into a set of content portions 216a, 216b, 216c and 216d, similar to the corresponding divided portions of the content instances 202, 204, 208 and 210. For example, a user of the device 206 may want to obtain the video file (or part thereof) and can therefore request that the content instance 216 be provided to the device 206. Through metadata which can be stored in the database 120, sources for the content portions 216a-d can be identified to the client device 206. For example, the content sources for the content instance 216 can include the devices 202, 204, 208 and 210.

Here, for example, the device 202 can be referred to the client device 206 through the metadata as a source for the content portion 216a. In this example, a transfer of the similar content portion 212a can be attempted from the device 202 to the device 206. This is schematically illustrated as an arrow from the device 202 to the device 206. If, for example, the transfer from the device 202 to the device 206 fails, such as in the case of a dropped connection, an invalid checksum calculation, or another such reason, the client device 206 can attempt to acquire the content portion 216 from another source. Here, for example, the device 210 can also be referred to the client device 206 by the metadata as a source for the content portion 216a. This is schematically illustrated as an arrow from the device 210 to the device 206.

In the illustrated example, the client device 206 may have already received the content portion 216b, for example in response to its request or in an earlier unrelated transfer. As another example, the device 206 in some situations can elect to not request a content source for the content portion 216b. This can be the case if the client device 206 does not require the content portion 216b; for example, the portion 216b can represent a component of an application program that the client device 206, or the user thereof, chooses not to install. In another example, the portion 216b can represent a segment of a video that the client device 206 chooses to skip when selecting a range of desired content.

In this example, the device 208 can be referred to the client device 206 as a source for the content portion 216c, and the device 204 can be referred to the client device 206 as a source for the content portion 216d. In this example, the content portion 218c can be noted through the metadata as a similar content portion as 216c, and a transfer of the portion 218c can be attempted from the device 208 to the client device 206. Likewise, in this example, the content portion 214d can be noted as a similar content portion as 216d, and a transfer of the portion 216d can be attempted from the device 204 to the client device 206. This is schematically illustrated as arrows from the devices 204 and 208, respectively, to the device 206.

Information regarding the transfer of data to the client device 206 can be sent to and stored by the database 120, and can serve as metadata for subsequent content requests, for example. In this example, after the client device 206 acquires content portions 216a, 216c and 216d, the device 206 can be registered as a content source for these portions.

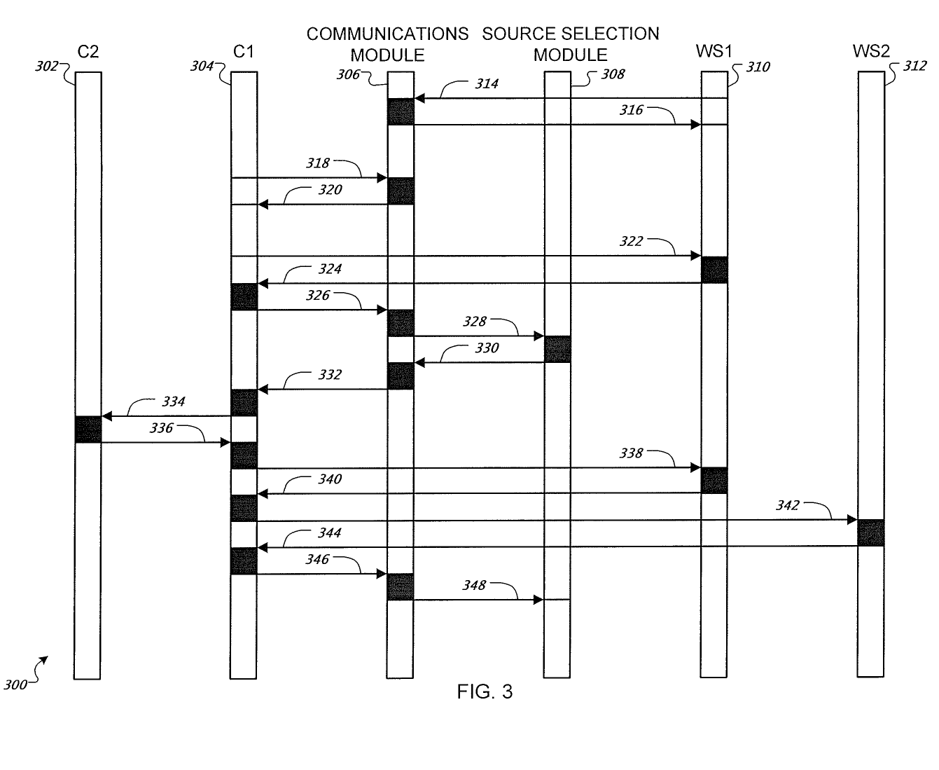

FIG. 3 shows a process 300 relating to delivering data over a network. In some implementations, the process can be performed in the system 100, for example by a processor executing instructions from a computer-readable storage device. In this example, the process 300 includes, but may not be limited to, a process 302 performed on a client device (C2) such as the client device 104b, a process 304 performed on a client device (C1) such as the client device 104a, a process 306 performed on a communications module such as the communications module 108, a process 308 performed on a source selection module such as the source selection module 116, a process 310 performed on a web server (WS1) such as the web server 106a, and a process 312 performed on a web server (WS2) such as the web server 106b.

As shown by arrow 314, a series of events for making content stored on the web server (WS1) available for distribution over a network, for example, can be initiated. This can be done by forwarding content information from the web server to the communications module. In this example, as shown by arrow 316, the communications module can process a content file and then forward it to the web server. Such content file processing can include dividing the file into portions, hashing the file or its portions, encrypting the file or its portions, generating metadata that can be used by the system, and/or any other processing which can facilitate security, reliability or efficiency of the data transmission. In this example, as shown by the arrow 316, the communications module can return processed file content to the originating web server (WS1), although in another embodiment the content can be delivered to a different network location or device.

To prepare for system content request, a client device can perform a setup operation that can allow it to participate as a client peer, for example. In this example, as shown by arrows 318 and 320, the client device (C1) can request and install a software program from the communications module. For example, the program 122 can be provided and subsequently installed on the client device. In another embodiment, the client device (C1) can acquire the software from a different source, such as a web server.

In this example, the client device (C1) can select and request information about desired content, as shown by arrow 322. For example, a user of the client device surfs the internet and opens a page from the web server. Here, as shown by arrow 324, the web server (WS1) can provide—e.g., together with the page—an identifier to content. That is, interaction between the client device and the web server can be facilitated though a web page sent from the server to the device, or through another mechanism, such as a computer program running on the device that connects to a web service program running on the server, for example.

The client device (C1) can request content from the system, as shown by arrow 326. The type of content that can be delivered by the system can include, but is not limited to, audio content, image content, video content, and application program content. A request for all content components or a subset of content components can be sent in addition to any relevant content identifier(s), as indicated by the arrow 326. In this example, the communication module can request sources for the desired application program content components from the source selection module, as shown by arrow 328. The source selection module can select sources for requested program content components based on an optimization algorithm, for example, and the selection module can provide a list of sources to the communication module, for further delivery to the client device (C1) as shown by arrows 330 and 332.

Potential content sources can include, but are not limited to, peer clients and web servers. In this example, the sources for the program content components requested by the client device (C1) include the peer client device (C2), the original content provider web server (WS1), and the web server (WS2), but it is also possible for content sources to include one or more other client peers, one or more web servers, or any combination thereof. In this example, one or more program content components are requested and downloaded from: the peer client device (C2), as shown by arrows 334 and 336; from the web server (WS1), as shown by arrows 338 and 340; and from the web server (WS2), as shown by arrows 342 and 344. In this example, the requested program content components can be installed by the client device (C1) once they are downloaded.

In some implementations, the client device requests to download less than all of the entire content. For example, a computer program running on the client device (C1) can be configured to initiate the installation of software on the device and the user of the client device (C1) can request that less than all of the components be installed. As another example, the user can choose to download only part of an audio or video file. In such situations, the client device may send request to fewer than all of the identified content sources.

In this example, the client device (C1) can report the status of the content transfer and/or installation, as shown by arrow 346. Report data can include information about the transfer process and the installation process, such as download rates of program content components, the eventual success or failure of downloads, the eventual success or failure of installations, and other relevant statistical information, for example. As shown by arrows 346 and 348, the information can be sent to the source selection module via the communications module, where the information can be recorded or updated, in a database, for example. The source selection module can retrieve and use the information in the selection of content sources for subsequent program content component deliveries.

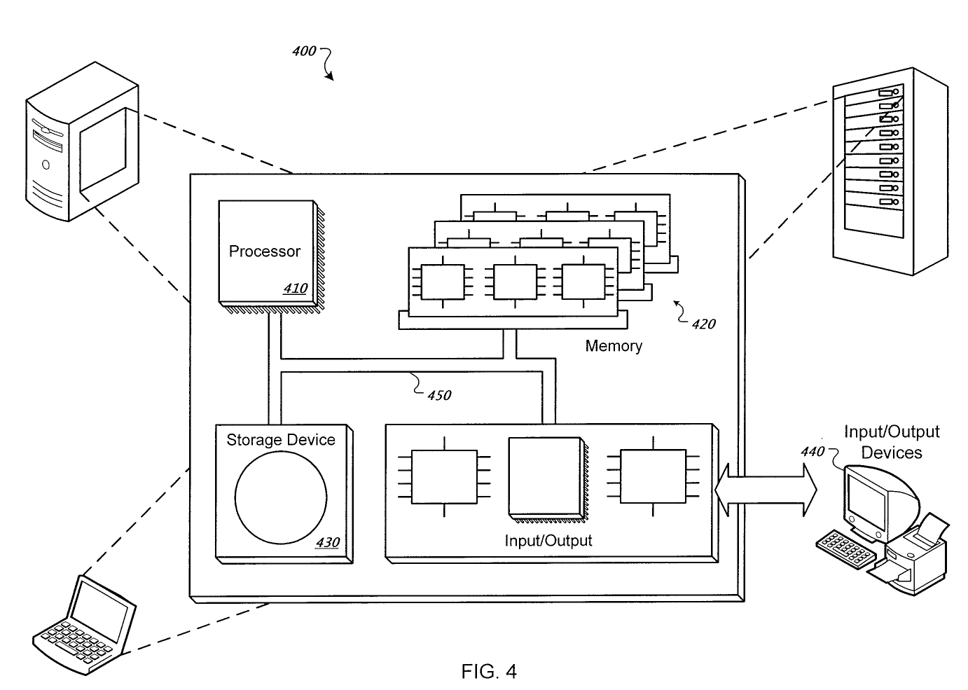

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer program product tangibly embodied in a computer-readable storage medium and comprising instructions that when executed by a processor perform a method for providing content in a network, the method comprising:
receiving an identifier that is forwarded from a device in a network and associated with content divided into content portions that are to be delivered to the device;
selecting a content source in the network for each of the respective content portions, wherein for at least one of the content portions the content source is selected among multiple content sources associated with the respective content portion using recorded information about the multiple content sources; and
forwarding, in response to the identifier, source information to the device that identifies each selected content source and is configured for use by the device in requesting at least one of the multiple content portions from each selected content source.

2. The computer program product of claim 1, wherein selecting the content source includes applying an optimization algorithm to the recorded information.

3. The computer program product of claim 2, wherein the optimization algorithm is configured so that the at least one content source is selected according to at least one approach selected from:
a network separation between the device and the content source being at most a predefined number of jumps;
a cost of forwarding at least one of the multiple content portions from the content source to the device being minimized;
a time required to forward at least one of the multiple content portions from the content source to the device being minimized;
a likelihood of successful forwarding of at least one of the multiple content portions from the content source to the device being maximized;
the content source being located in a predefined network in which the device is also located;
the content source being associated with an internet service provider with which the device is also associated;
the content source being located in a geographic location in which the device is also located; and
combinations thereof.

4. The computer program product of claim 1, wherein the recorded information reflects at least one characteristic selected from:
a speed of communication to the device;
a speed of communication from the device;
whether communication with the content source has been successful;
whether the content source has a public internet protocol (IP) address;
whether the content source has a private IP address;
an internet service provider with which the content source is associated;
a geographic location with which the content source is associated;
a subnet in which the content source is located; and
combinations thereof.

5. The computer program product of claim 1, wherein the source information identifies a plurality of content sources for at least one of the content portions.

6. The computer program product of claim 1, wherein the content includes at least one content type selected from: audio content, image content, video content, application program content, and combinations thereof.

7. The computer program product of claim 1, wherein the method further comprises:
receiving a confirmation from the device after the device requests the multiple content portions, the confirmation including information about a result of the requests generated by the device; and
updating the recorded information using the confirmation.

8. The computer program product of claim 7, wherein the method further comprises:
registering the device as a content source for the content.

9. A computer program product tangibly embodied in a computer-readable storage medium and comprising instructions that when executed by a processor perform a method for providing content in a network, the method comprising:
forwarding an identifier associated with an object from a device to a first server device in a network, the object including content divided into content portions that are to be delivered to the device;
receiving, at the device and from the first server device, source information that identifies a selected content source for each of the respective content portions, wherein for at least one of the content portions the content source was selected among multiple content sources associated with the respective content portion using recorded information about the multiple content sources; and
obtaining the content using the received source information.

10. The computer program product of claim 9, wherein the instructions are included in a program on the device that is associated with the first server device, the program configured to interact with a browser on the device presenting the page that was received from a second server device.

11. The computer program product of claim 10, wherein the program is configured to initiate installation of software on the device and wherein the content includes the software, the method further comprising:
installing the software on the device from the content.

12. The computer program product of claim 11, the method further comprising:
receiving an input from the user indicating that at least one part of the software is not to be installed; and
providing that any of the content portions corresponding to the part are not requested by the device.

13. The computer program product of claim 9, the method further comprising:
displaying, before forwarding the identifier, a page on the device that includes a representation of the object; and
obtaining the identifier from the displayed page upon a user selecting the representation of the object.

14. The computer program product of claim 13, wherein the page includes script code associated with the representation of the object, the script code instructing the device to obtain the identifier from the page upon the user selecting the representation and forward the identifier to the program, wherein the program forwards the identifier to the first server device.

15. The computer program product of claim 9, wherein obtaining the content comprises:
specifying, for each of the content portions, a range command corresponding to the content portion being requested; and
forwarding a request including the range command to the content source for the content portion.

16. The computer program product of claim 9, wherein the method further comprises:
sending a confirmation from the device to the first server device after the device requests the multiple content portions, the confirmation including information about a result of the requests generated by the device, wherein the first server device updates the recorded information using the confirmation

17. A computer system comprising:
a communication module receiving an identifier that is forwarded from a device in a network and associated with content divided into content portions that are to be delivered to the device; and
a source selection module selecting a content source in the network for each of the respective content portions, wherein for at least one of the content portions the content source is selected among multiple content sources associated with the respective content portion using recorded information about the multiple content sources;
wherein the communication module forwards, in response to the identifier, source information to the device that identifies each selected content source and is configured for use by the device in requesting at least one of the multiple content portions from each selected content source.

18. A computer program product tangibly embodied in a computer-readable storage medium and comprising instructions that when executed by a processor perform a method for providing content in a network, the method comprising:
receiving, at a first server device and from a device in a network, an identifier that is associated with content divided into content portions that are to be delivered to the device, wherein to obtain the identifier the device:
displays in a browser a page including a representation of an object that includes the content, the representation associated with the identifier and the page provided to the device from a second server device, wherein a user selects the representation on the page;
forwards the identifier from the browser to a program on the device that is associated with the first server device, the identifier forwarded according to communication instructions provided from the first server device; and
forwards the identifier to the first server device using the program;
selecting, at the first server device and using the received identifier, at least one of a plurality of third server devices in the network as a content source for each of the respective content portions, wherein for at least one of the content portions the content source is selected by applying an optimization algorithm to recorded information about the plurality of third server devices; and
forwarding, in response to the identifier, object information and source information to the device, the object information describing the object and the multiple content portions, the source information identifying each selected content source, wherein the device:
obtains the content using the received object information and source information using the program;
forwards the obtained content from the program to the browser; and
presents the content in the browser.
